(19) United States
(12) Patent Application Publication
(10) Pub. No.: US 2014/0159692 A1
(43) Pub. Date: Jun. 12, 2014

(54) SYSTEM AND METHOD OF AUTOMATIC DIMMER LOADING IN DIMMER-CONVERTER ARRANGEMENTS

(71) Applicants: Victor TZINKER, Jerusalem (IL); Sergey KHARITON, Nazareth Illit (IL); Alexander FIRTEL, Ashdod (IL)

(72) Inventors: Victor TZINKER, Jerusalem (IL); Sergey KHARITON, Nazareth Illit (IL); Alexander FIRTEL, Ashdod (IL)

(21) Appl. No.: 13/944,903

(22) Filed: Jul. 18, 2013

Related U.S. Application Data
(60) Provisional application No. 61/672,794, filed on Jul. 18, 2012.

(51) Int. Cl. H02M 3/156

(52) U.S. Cl. CPC H02M 3/156
USPC 323/284

(57) ABSTRACT

The present invention provides systems and methods for automatic dimmer loading in a cut-phase dimmer-converter arrangement, the method including providing minimum dimmer hold-on current by continuously loading of the dimmer with the current grater than minimum hold-on dimmer current without current measurement means or with using of measurement means by measuring a first current across the dimmer to form a current output signal and compensating for a drop in the dimmer output current by adding a load current across said dimmer to ensure that a total current comprising a sum of the first current and the load current always exceeds a threshold current for continuous operation of the dimmer.

### FIELD OF INVENTION

This invention relates generally to power supplies, and particularly to dimmer-electronic converter-load systems, used in home appliances, the lighting industry and other industrial systems.

### BACKGROUND OF THE INVENTION

In modern life, there is a general need to regulate the power of various loads, used in the industry and home appliances, such as the power of lighting systems, heaters and the like. Simple cut-phase electronic dimmers are often used for this purpose. Their operating principle is based on cutting a part of a sine half-cycle. Two types of dimmers can be distinguished, according to which part of the sine half-cycle is cut, leading edge dimmers or trailing edge dimmers. They are both usually based on TRIACs. The difference between them is that the leading edge dimmers cut the rising part of the sine waveform and the trailing edge dimmers cut the falling part of the sine waveform.

During the last decades, popularity of different types of low cost electronic converters for powering low voltage loads, such as incandescent lamps, Light Emitting Diodes (LEDs), and other low voltage loads has risen, especially in the lighting industry and the home appliance sector. These converters have replaced the magnetic power transformers, which are more expensive, larger and heavier, for providing the same power.

Low cost electronic converters are used in different dimmable systems, with cut-phase dimmers at the input. As a result, there arises the need for ensuring stable operation of the whole dimmer-electronic converter-load system for a wide dynamic range of loads.

Currently, there is a trend to replace low-voltage incandescent lamps by LEDs. The latter represent non-linear loads, for which it is difficult to ensure stable operation of the dimmer, particularly at low loads, wherein the consumption current of the electronic converter is near or below the latching current of the dimmer's Triode for Alternating Current (TRIAC). The TRIAC is a genericized tradename for an electronic component that can conduct current in either direction when it is triggered.

Additional constraints for stable operation of the system, including the dimmer, are short interrupts, drops in the dimmer current as a function of a malfunction of the subsequent power conversion chain, dimmer input or power line input.

In the following summary and description, the dimmer behavior specified by the terms “latching current” and “holding (hold-on) current” are defined as follows:

Latching current: the current specified as forward TRIAC current sufficient for latching the TRIAC structure;

Holding (Hold-on) current: the current specified as forward TRIAC current sufficient for holding the TRIAC structure in the conduction state.

For simplicity of further explanation, the following summary and description uses the uniform term “latching current” for both cases

If, for any reason, there is a very short current drop under the dimmer latching current value, (for example as a result of electronic converter malfunction, LED load cutting off, etc.), the dimmer current interrupts at the same moment. This leads to a relatively “long” interrupt of the powering and initiates an unpredictable process.

An obvious example of the malfunction conditions that can be reviewed is the input power line drop, which can cause dimmer cut-off due to dimmer current drop below the dimmer's latching current, and as a result malfunction of one of the elements of the power conversion chain. Therefore it is important to provide the dimmer with minimally higher current than its latching current under any dimmer conditions.

Difficulties for the dimmer operation may occur in the case of a magnetic transformer connection between the dimmer and the load and in the case of a direct connection of the lamp or heater load to the dimmer due to the transformer or load behavior under specific conditions. The common dimmer behavior convenient to review applies to the example of a simple TRIAC based dimmer.

A major constraint for the dimmer utilization is the functioning in series with the electronic converter. In view of the fact that in a variety of applications, an electronic converter starts its operation with a time delay, there is an additional challenge to provide stable operation of the dimmer—electronic converter—load arrangement.

For the cut-phase dimmer, implemented with a TRIAC, at the moment of application of the input voltage to the dimmer—electronic converter arrangement, the dimmer load doesn't provide the dimmer minimum current, sufficient for dimmer power-up and latching, before an electronic converter starts its operation. The dimmer may switch it on at the first moment, for example, as result of current drawn across the capacitance applied at the dimmer output.

If the current applied at the dimmer output, causes the capacitance to be charged on before the dimmer load powers on, the current drawn from the dimmer drops to an insufficient level to provide dimmer current greater than the TRIAC's latching current.

As a result, the TRIAC doesn't turn on at all, because the initial dimmer current is insufficient or turns itself off after the initial current drawn by the capacitance drops below the TRIAC current latching value. Usually, the energy of the capacitance is insufficient for the converter to turn on, and therefore the converter discharges the capacitance before the converter has turned on.

Discharged dimmer output capacitance provides an important condition for the next dimmer power-up ignition.

The minimum conditions for the dimmer ignition are:

being greater than a certain voltage difference across the dimmer; and

sufficient initial dimmer current drawn from the dimmer by the load.

The dimmer will “try” to turn itself on again automatically when the next firing conditions arise in the present half-cycle, or at the next half-cycle of the mains (AC input power line) voltage. This operation produces oscillations of the input voltage for the following power conversion chain, and may cause unpredictable behavior.

Dimmer load behavior during the start of its operation or under unstable power conditions is an additional challenge for the dimmer-converter-load arrangement. The dimmer load may consist of the chain of energy conversion elements connected in different way, with a different reaction to the applied energy. An oscillation of the voltages applied on the elements of the chain induces additional stresses in the elements of the energy conversion chain, including components of the electronic converter and cause reduction of the mean time between failures (MTBF) of the chain.

For electronic converters operated in series with a dimmer, two main problematic modes can be noted: start-up mode and mode of operations with low or pulsed loads.

In electronic converters, operated in series with a dimmer, problematic operation may occur during the start-up of the electronic converter and/or when the current consumption of the electronic converter is smaller than the latching current of the dimmer, or the dimmer's TRIAC in the case of simple TRIAC based dimmer. This occurs, for example, as a result of low load or fault conditions. Under these conditions, the converter's current consumption is not sufficient to bring the dimmer into its normal operating mode. As a result, either the dimmer is completely switched off, or the dimmer-converter system produces oscillations, due to accidental current fluctuations in the vicinity of the latching threshold.

For instance, the converter's input capacitance should be taken into account as transient dimmer load. The capacitance, discharged by the subsequent conversion chain, may provide sufficient dimmer switch-on current and supply relatively large current to the subsequent converter. However, the capacitance is usually charged up to the main instantaneous voltage and owing to the current drawn from the dimmer is close to zero before the subsequent conversion chain starts its operation. As a result the dimmer turns-off.

The energy accumulated in the capacitance is insufficient for the electronic converter start-up, therefore the electronic converter discharges its input capacitance before it started-up and the sequence is repeated.

The two main obvious requirements should be provided for the arrangement with the dimmer connected at its input, for its successful start-up:
initial dimmer current should exceed required dimmer hold-on current; and
dimmer current consumption during the power-up of the following arrangement should exceed latching current of the dimmer.

Therefore, it is essential to provide a hold on the dimmer under any conditions, including during the start-up period and in operation with low or pulsed loads. Continuous current consumption must be ensured, sufficient to keep the dimmer's current above the required threshold.

Prior art FIG. 1 shows an example of the TRIAC based dimmer 10. Dimmer 10 is connected to an AC source 11 in series with a inductor 12 through a pair of lines 18 and 19. Dimmer 10 includes a capacitor 17, which is charged through the serial combination of an inductor 12 and a variable resistor 16.

A diode for alternating current (DIAC) 15 is connected to a gate of TRIAC 14. When the voltage on capacitor 17 reaches the breakdown voltage of DIAC 15, TRIAC 14 fires. The dimmer current, i.e. the current of TRIAC 14, is supplied to LOAD 110 through inductor 12. The DIAC is a diode that conducts current only after its breakover voltage has been reached momentarily. When this occurs, the diode enters the region of negative dynamic resistance, leading to a decrease in the voltage drop across the diode and, usually, a sharp increase in current through the diode. The diode remains “in conduction” until the current through it drops below the latching current for the device. Below this value, the diode switches back to its high-resistance (non-conducting) state. This behavior is bidirectional, meaning typically the same for both directions of current.

At the end of the AC input power line (mains) half-cycle, the level of current in TRIAC 14 decreases below its latching current (i.e. minimum anode current necessary to sustain conduction of TRIAC 14) and TRIAC 14 turns off. A firing angle, i.e., the angle between 0 and 180 degrees, at which TRIAC 14 first conducts, can be adjusted by varying the resistance of variable resistor 16. Variable resistor 16 can be, but is not limited to, a potentiometer. The minimum firing angle is limited by the breakdown voltage of DIAC 15. Inductor 12 limits the rise or fall time, or rather, dl/dt, and thus protects TRIAC 14 and improves electro-magnetic interference (EMI) behavior.

A capacitor C1 serves as a snubber and prevents flickering. Snubbers are frequently used in electrical systems with an inductive load, where the sudden interruption of current flow leads to a sharp rise in voltage across the current switching device, in accordance with Faraday's law. This transient can be a source of EMI.

U.S. Pat. No. 5,994,848, to Janczak, discloses a method of maintaining the current drawn from the cut-phase dimmer at a level above the latching current of the TRIAC, especially at small angles of the dimmer. The method is based on a power feedback circuit (capacitor) from the output of the ballast to ground of buffer capacitor via fast recovery diodes. Overshoots of the boost voltage on the buffer capacitor are reduced during low dim levels. This method has the following disadvantages:
Unacceptably high overshoots of boost voltages on the buffer capacitor will still occur during low level dimming, e.g. about 10%.
There is a need to change the values of components in order to accommodate different types of TRIACs and loads (for example, lamps).
Changing values of components makes it difficult to modularize power supplies.

WO2011/141905, to Tzinker et al., discloses an AC-DC converter with a unity power factor. A method is disclosed for construction of voltage or current power sources receiving an AC input, the power sources based on inclusion of a buffer stage feeding a converter operating with an output driver to a load. The buffer stage includes a buffer capacitance and a control means, such that the consumed input current from the AC input is proportional to the AC input voltage to the power source. The buffer capacitance functions as a charge buffer, enabling maintenance of the consumed input current over the entire period of the AC input voltage and acting to separate the load from the consumed input current.

This method enables emulating active loads for the dimmer, eliminating current drop during the load cut-off, and as result ensures stable operation of dimmer-electronic converter-load arrangements. However, this method does not provide conditions for stable operation during the start-up and low load conditions.

### SUMMARY OF THE INVENTION

Accordingly, it is a principal object of the present invention to maintain current drawn from a dimmer at least at the level of the TRIAC latching current during a delay between the application of voltage and the start of operation of the electronic converter. This is especially important at small dimmer angles, where the delay is significant.

A further object of the present invention is to maintain the level of current drawn from a dimmer to at least the level of the TRIAC latching current, when the current drawn from the dimmer by the converter drops below the operational threshold level of the dimmer.

According to a first aspect of the present invention, one object is realized using an Automatic Dimmer Loader (ADL), which loads the dimmer during the start-up time of the electronic converter.

According to another aspect of the present invention the ADL loads the dimmer continuously with current which is greater than the minimum dimmer latching current without dimmer current sensing means.

According to additional aspect of the present invention the ADL senses the dimmer current and loads the dimmer when necessary, to maintain the minimal dimmer current level.

There is thus provided according to an embodiment of the present invention, a system for automatic dimmer loading in a dimmer-converter-load arrangement, the system including;

dimmer current sensing means;

an energy receiving unit;

a ballast for providing the required current range of the energy receiving unit;

a ballast control system with appropriate feedbacks and control signals; and

an energy receiving unit control means,

wherein the loader is adapted to load the dimmer, providing stable operation thereof, and wherein measurement means of the loader are placed in the dimmer-converter arrangement in such a place where they can satisfactorily measure the current of the dimmer and wherein the loader is placed in the system in such a way that enables correct loading of the dimmer.

Additionally, according to an embodiment of the present invention, the energy receiving unit further includes an energy storage element.

Furthermore, according to an embodiment of the present invention, the system further includes an energy receiving unit control means, and such control means being configured to convert, transfer or dissipate energy of the energy storage element.

Moreover, according to an embodiment of the present invention, the energy receiving unit further includes at least one energy dissipation element, active or passive.

According to some embodiments, the system further includes an energy conversion element.

Additionally, according to an embodiment of the present invention, the loader is adapted to maintain a suitable current drawn from the cut-phase dimmer during a delay between application of an input voltage and the start of the converter operation, i.e., during the start-up time of the converter, the current being at least as great as the latching current of the dimmer.

Further, according to an embodiment of the present invention, the loader is adapted to maintain the dimmer current, at least at the level of the latching current, under any dimmer conditions when an input voltage is applied.

Yet further, according to an embodiment of the present invention, the converter in dimmer-converter-load arrangement is any type of conversion means including an electronic converter.

Additionally, according to an embodiment of the present invention, an energy receiving unit control means provides zero initial conditions for each operation cycle of the dimmer and the loader, providing optimal and required conditions for dimmer firing and dimmer loading, such as maximum energy capacitance of the receiving unit before each operating cycle and minimum and/or required firing angles of the dimmer. Since the minimum firing angle is defined by the voltage difference across the dimmer, the minimum initial (zero) voltage on the receiving unit before each operation cycle defines the minimum dimmer angle.

Further, according to an embodiment of the present invention, the stable initial (zero) voltage provides stable dimmer firing conditions, and as a result, stable dimmer firing at the required angle under any dimmer conditions.

Yet further, according to an embodiment of the present invention, the minimum initial (zero) voltage on the receiving unit before each operating cycle and maximum energy capacitance of the receiving unit are provided in order to guarantee dimmer latching current at minimum dimmer firing angle under any dimmer conditions.

Moreover, according to an embodiment of the present invention, the dimmer current sensing means and the dimmer loader may be separate parts of the loader, and may be placed in different places in the arrangement.

Additionally, according to an embodiment of the present invention, the current sensing means and the dimmer loader are not necessary galvanically coupled.

Further, according to an embodiment of the present invention, the dimmer loader loads the dimmer and is configured as a part of an electronic converter.

Yet further, according to an embodiment of the present invention, the dimmer loader provides a suitable dimmer current without dimmer current sensing means.

Additionally, according to an embodiment of the present invention, the dimmer loader operates without a ballast control system.

Moreover, according to an embodiment of the present invention, the ballast control means provides ballast operation with the required minimum dimmer current under any dimmer conditions.

Additionally, according to an embodiment of the present invention, the energy receiving unit of the dimmer loader operates without an energy receiving unit control means.

Furthermore, according to an embodiment of the present invention, the dimmer loader includes:

an input decoupling diode;

current sensing means;

a ballast;

a ballast control system with appropriate feedbacks and control signals;

an energy receiving unit; and

an energy receiving unit control means.

Additionally, according to an embodiment of the present invention, the dimmer loader providing cut-phase dimmer loading is configured as an independent device.

Furthermore, according to an embodiment of the present invention, the dimmer loader includes:

an input rectifier;

current sensing means;

a ballast;

a ballast control system with an appropriate feedback and control signals;

an energy receiving unit;

an energy receiving unit control means; and

an energy utilization means.

Furthermore, according to an embodiment of the present invention, the dimmer loader providing cut-phase dimmer loading is configured as a part of an electronic converter and contains an energy utilization means, where the energy utilization means transfers the energy accumulated by the energy receiving unit to the converter directly or by additional conversion means. The dimmer embodiment includes:
an input rectifier;
a current sensing means;
a ballast;
an energy receiving unit;
an utilization converter;
a ballast control system with appropriate feedbacks and control signals, which controls the ballast and utilization converter; and
a capacitor.

Furthermore, according to an additional embodiment of the present invention, the dimmer loader providing cut-phase dimmer loading provides the energy utilization without a utilization converter and/or without a ballast control system.

Furthermore, according to an additional embodiment of the present invention the utilization converter is a step-up converter.

Furthermore, according to an embodiment of the present invention, the dimmer loader is based on a step-down converter, which provides a constant current at its input, which is greater than the dimmer latching current under any dimmer conditions.

Additionally, according to an embodiment of the present invention, the step-down converter measures the total dimmer current and controls the input current of the loader in order to maintain a minimum required level of the dimmer current.

Additionally, according to an embodiment of the present invention, the step-down converter includes elements that provide dimmer loading during the power on time of the step-down converter.

There is thus provided according to another embodiment of the present invention, a method for automatic dimmer loading in a dimmer-converter-load arrangement, the method including:
continuously measuring the current through the dimmer; and
compensating for a possible drop in the dimmer current by addition of a load current of the dimmer to ensure that the total load exceeds the threshold current for continuous operation of the dimmer.

Furthermore, according to an embodiment of the present invention, the compensating step includes maintaining the total load current at least at the threshold level during a delay between the application of an input voltage and the start of the converter operation latching.

Additionally, according to an embodiment of the present invention, the compensating step includes continuously maintaining the current drawn from the dimmer at least at the level of the dimmer's latching current, when the current drawn from the cut-phase dimmer drops towards the dimmer's latching current, at any time and during any operating conditions.

Moreover, according to an embodiment of the present invention, the method further includes providing optimal initial conditions for each operating cycle of the dimmer and the loader, such as minimum voltage on the energy receiving unit capacitance before each operation cycle in order to maintain the required firing angle of the dimmer, including the minimum possible value of the angle. Since the minimum firing angle is defined by the voltage difference across the dimmer, the minimum voltage on the receiving unit before each operation cycle defines the minimum dimmer angle.

Further, according to an embodiment of the present invention, the stable initial voltage ensures stable dimmer firing conditions and consequently stable dimmer firing at a required angle under any dimmer conditions.

Yet further, according to an embodiment of the present invention, the minimum initial voltage on the receiving unit before each operating cycle and maximum energy capacitance of the receiving unit are provided in order to guarantee dimmer latching current at the minimum dimmer firing angle under any dimmer conditions.

Further, according to an embodiment of the present invention, the compensating step further includes maintaining a voltage across an energy receiving unit in order to provide the dimmer ignition at the minimal required angle and/or energy receiving unit overvoltage protection.

Yet further, according to an embodiment of the present invention, the compensating step is designed to operate during the start-up period of the converter.

Furthermore, according to an embodiment of the present invention, the energy receiving unit further includes an energy storage element.

Additionally, according to an embodiment of the present invention, the energy receiving unit further includes an energy receiving unit control means, the control means being configured to convert, transfer or dissipate energy of the energy storage element.

Furthermore, according to an embodiment of the present invention, the energy receiving unit further includes at least one active or passive energy dissipation element.

Additionally, according to an embodiment of the present invention, the system further includes an energy conversion element.

Furthermore, according to an embodiment of the present invention, the loader is a resistive loader.

Further, according to an embodiment of the present invention, the loader is based on power conversion means.

Yet further, according to an embodiment of the present invention, the loader power conversion means provides dimmer loading with minimum dimmer current under any dimmer conditions, and is thereby able to latch the dimmer by drawing a minimum current under any dimmer conditions.

Additionally, according to an embodiment of the present invention, the loading is provided without dimmer current control means.

According to some embodiments, the loading is provided without ballast control means.

Furthermore, according to an embodiment of the present invention, the energy receiving unit of the dimmer loader operates without an energy receiving unit control means.

Additionally, according to an embodiment of the present invention, the converter placed between the dimmer and its load in the dimmer-converter-load arrangement, can be one of an electronic converter, a magnetic converter, a passive load in the form of either a resistance or a lamp, or any other type of converter known in the art.

.Additionally, according to an embodiment of the present invention, the compensation loading is achieved by means of a step-down converter, which provides a minimum current at its input, and greater than the minimum dimmer latching current under any dimmer conditions.

Furthermore, according to an embodiment of the present invention, the step-down converter measures the total dimmer current and provides a complementary dimmer current at its input in order to provide the minimum dimmer current level.

The present invention will be more fully understood from the following detailed description of the preferred embodiments thereof, taken together with the drawings.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

Prior art FIG. 1 is a schematic diagram of an exemplary prior-art conventional cut-phase dimmer, based on the TRIAC, as currently used in the lighting industry, home appliances, and other industries;

FIG. 2 is a functional block diagram of an Automatic Dimmer Loader (ADL), constructed in accordance with the principles of the present invention;

FIG. 3 is a detailed functional block diagram of the ADL, constructed in accordance with the principles of the present invention;

FIG. 4 illustrates wave forms, which explain the operation of the ADL, constructed in accordance with the principles of the present invention;

FIG. 5 shows a functional block diagram of Independent the ADL device architecture, constructed in accordance with the principles of the present invention;

FIG. 6 illustrates the functional diagram of an improved the ADL including energy utilization means, constructed in accordance with the principles of the present invention; and

FIG. 7 illustrates the wave forms which explain the operation of improved the ADL with energy utilization means, constructed in accordance with the principles of the present invention.

In all the figures similar reference numerals identify similar parts.

### DETAILED DESCRIPTION OF EXEMPLARY EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

The concept of the present invention is particularly suitable for dimmer—electronic converter—load systems used in the lighting industry although it is not limited thereto. For the sake of simplicity, the concept will be explained for lighting systems, but this should not be deemed as limited thereto.

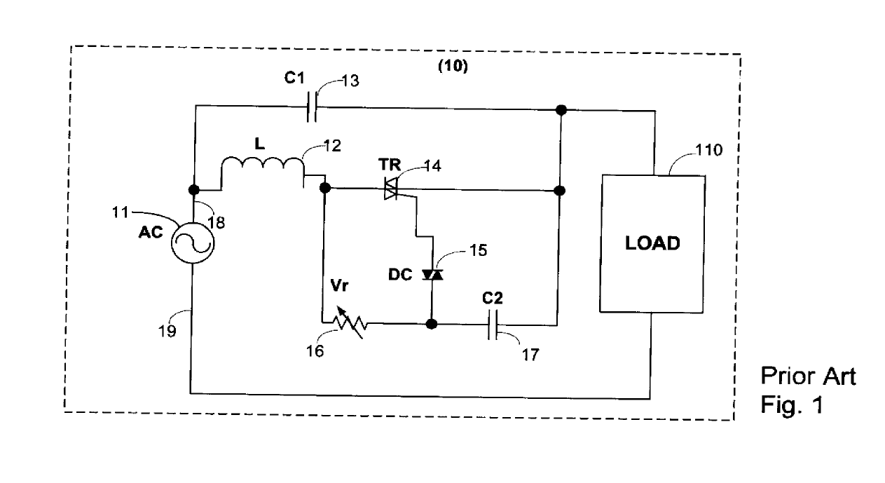

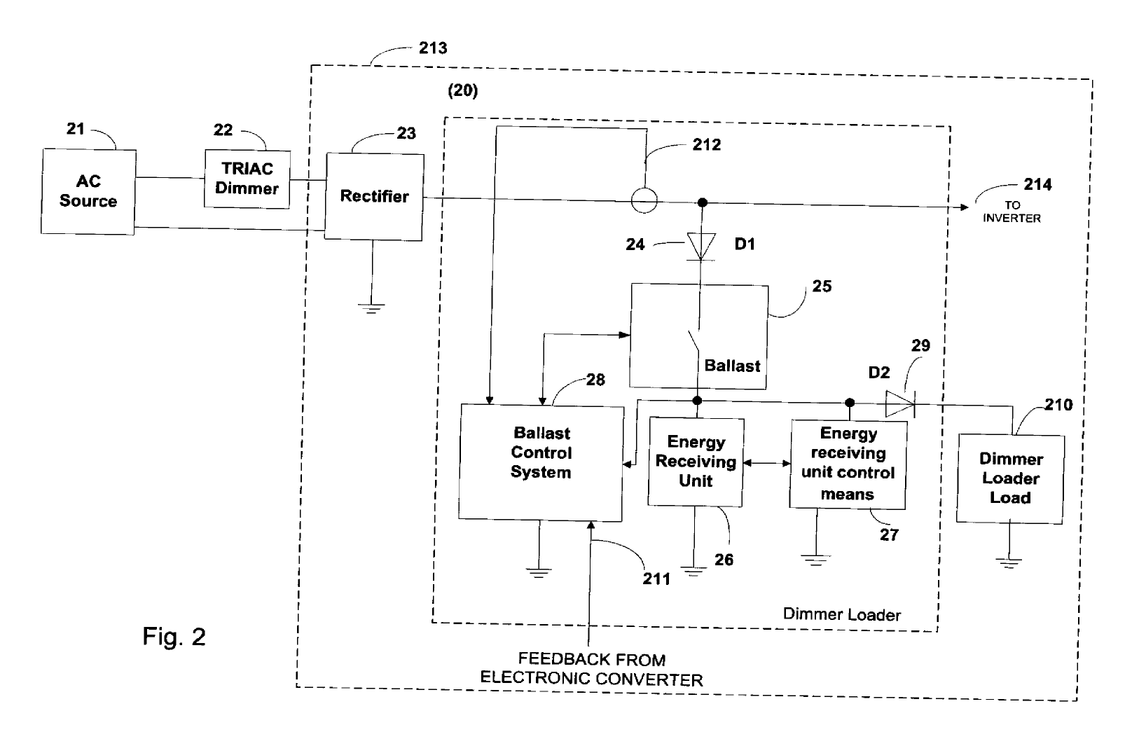

The operational principles of the present invention are explained in reference to FIG. 2, showing the functional structure of Automatic Dimmer Loader (ADL) 20 connected after an input rectifier 23 of an electronic converter 213.

An input AC voltage is passed through a conventional TRIAC dimmer 22 and rectified by a rectifier 23, which is connected to ADL 20. The ADL comprises an energy receiver unit 26 (ERU), connected to a rectifier 23 through a decoupling diode D1 24 and a ballast 25, which defines the current flows to Energy Receiver Unit 26. Ballast 25 is controlled by a Ballast Control System 28, which has two inputs, namely an input from current sensor 212 and feedback 211 from electronic converter 213, which disables or enables the operation of the ADL depending on the operational status of electronic converter 213.

If the converter status is “on,” then the operation of the ADL is disabled and vice versa. In addition, Ballast Control System 28 enables or disables the operation of ADL 20 based on the actual value of the electronic converter input current. If the latter drops to a value close to the latching current of the dimmer's TRIAC, then Bak last Control System 28 enables the operation of ADL 20 in order to prevent dropping under the latching current of the dimmer's TRIAC. Otherwise it disables the operation of ADL 20. Energy receiving unit control means 27 are connected in parallel to Energy Receiver Unit 26 and is used in order to achieve the zero initial conditions suitable for proper operation of ADL 20 and protect from over-voltage conditions of Energy Receiver Unit 26. The energy received by Energy Receiver Unit 28 can be dissipated or converted. This energy also may be transferred to the Dimmer Loader Load 210 or utilized for powering of electronic converter's control circuits through decoupling diode D2 29 or utilized in any other form.

The Ballast Control System 28 receives power from Energy Receiver Unit 26. This input can be used for Energy Receiver Unit 26 overvoltage protection. The Ballast Control System 28 should interrupt the ballast current during Energy Receiver Unit 26 overvoltage conditions.

Ballast Control System 28 can be implemented as an analog, digital or mixed signal control system. Energy Receiver Unit 26 can be implemented as a capacitor, but not is limited thereto.

In the case where the start-up at small dimmer angles must be maintained, two basic restrictions are preferably fulfilled:
During the hold-on period, the voltage difference between instantaneous mains voltage and voltage on the Energy Receiver Unit 26 V_{ERU} should be greater than the forward voltage drop of the voltage of the dimmer's TRIAC 14, (Vₘₐᵢₙₛ−V_{ERU})>V_{F}, otherwise the conditions for TRIAC 14 conduction and system start are insufficient.
Inverter 214 start-up time depends on the input voltage in the following manner: the higher the input voltage, the shorter the duration of the inverter's start-up. At small operating angles of the dimmer, the inverter's start-up time may be significantly longer due to the low input voltage. In order to shorten the inverter's start-up time and consequently shorten the latching period of ADL 20, the inverter's start-up time can be reduced by appropriate design of the power supply circuits of the inverter.

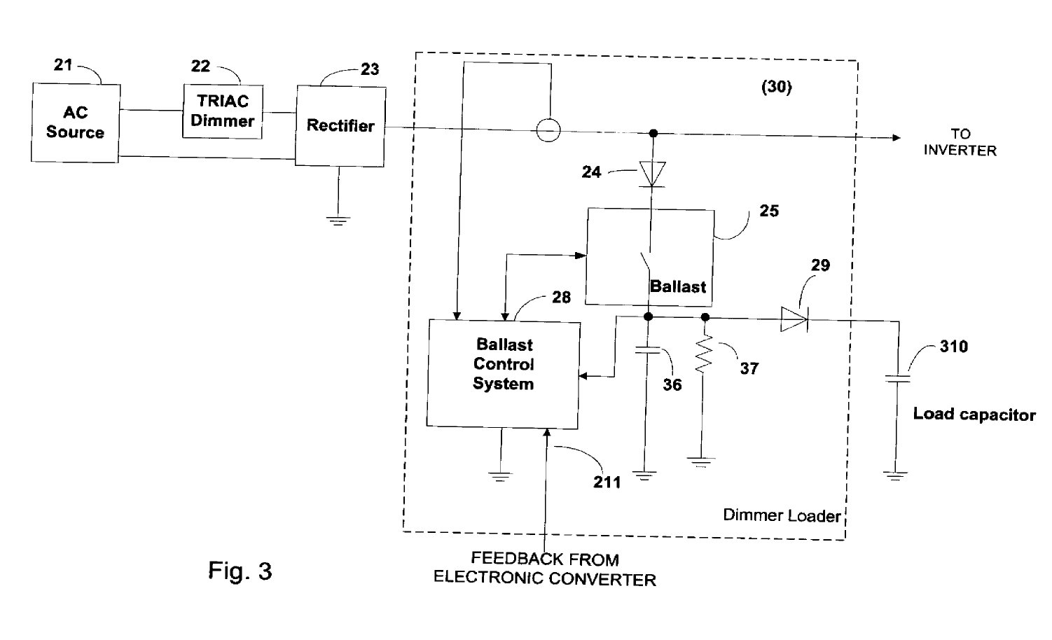

FIG. 3 is a detailed functional block diagram, which illustrates the method of dimmer latching, i.e., the implementation of energy receiver unit 26 and energy receiving unit control means 27 described with reference to FIG. 2. The circuitry in FIG. 3 includes an input rectifier 33; a decoupling diode 34; a ballast 35; a storage capacitor 36 with resistor 37 connected in parallel in order to provide zero initial conditions, wherein storage capacitor 36 can receive maximum energy; and a decoupling diode 39 adapted to decouple the load from storage capacitor 36. Ballast Control System 38 controls the behavior of ballast 35 in order to provide sufficient current for latching the dimmer for time period T, required to start the operation of the electronic converter. Moreover, after startup of the converter, ballast control system 38 disconnects storage capacitor 36 by interrupting the ballast current and energy stored in capacitor 36 dissipates on resistor 37 in order to enable receiving energy at any moment if ballast control system 38 connects ballast 35 to storage capacitor 36.

The current flowing through ballast 35 provides, together with dimmer's load (electronic converter), current sufficient for normal operation of the dimmer.

In a case where the ballast 35 is an electronic converter, control system 38 can add minimum current to the current drawn by the dimmer's load, in order to achieve normal operation of the dimmer.

In order to synchronize transformation of the energy stored in storage capacitor 36, conversion means should be provided. In a case where the ballast is a resistive one, it is difficult to provide only minimum latching current of the dimmer in the case of wide input voltage changes because resistive ballast should be chosen in order to provide latching current at minimal input voltage and minimal conduction angle, when the dimmer conducts the current during the short time of the mains period.

$${R}_{ballast} = \frac{{V}_{i n \_ min}}{{I}_{min}} . \qquad ( 1 )$$

Here
Vᵢₙ_{_{—}}ₘᵢₙ—actual instantaneous voltage at minimum main operating voltage and conduction angle of the dimmer;
V—the maximum voltage on capacitor C_{chg};
Imin—latching current of the dimmer plus certain safety margin.

The storage capacitor value, C, can be calculated according to the following energy balance equation

I_{RMS}·T=C·V (2)

Here
T—maximum time needed to start of the electronic converter;
V—the maximum voltage on capacitor C_{chg}.
V_{RMS}—the RMS value of the mains voltage
I_{RMS}—the RMS value of the ballast resistor current in the worst case (when dimmer almost always conducts) and can be calculated by the following equation (in this case it is equal to charge current of the capacitor):

$${I}_{RMS} = \frac{{V}_{RMS}}{{R}_{ballast}} \qquad ( 3 )$$

Here
V_{RMS}—RMS mains voltage
R_{ballast}—resistance of the ballast resistor

In this case minimum current drawn by storage capacitor 36 at minimum input voltage but at maximum voltage point dimmer is loaded by enlarged current and this current charges the load capacitor.

In a case where the ballast is able to provide its output constant current under any input conditions, for example by using of conversion means it is able to provide lower RMS current relating to the resistive ballast option. For this option output constant current should provide minimum dimmer current at maximum input voltage,

$$I = \frac{{I}_{min}}{{V}_{input max} / {V}_{min}} \qquad ( 4 )$$

Here
V_{input max}—maximum instantaneous input voltage value;
Iₘᵢₙ—a current which is greater than max latching current of the dimmer's TRIAC by a certain safety margin;
Vₘᵢₙ—the minimal voltage on capacitor C_{chg};
C of the storage capacitor 36 can be calculated according to the following energy balance equation

T·I=C·V (5)

Here
T—maximum time needed to start of the electronic converter;
I—ballast output constant current which provides at the input of the ballast current greater than max latching current of the dimmer's TRIAC by a certain safety margin in any dimmer conditions.
V—the maximum voltage on capacitor C_{chg};

In described above solution sufficient dimmer current is provided under any input conditions. The current drawn from the dimmer to special storage capacitance changes with the input voltage, but its RMS value is lower relative to the resistive ballast option. The charging current of the storage capacitor is constant for any input voltage point. For this solution a lower energy is received by storage capacitance in order to provide stable dimmer operation and as result a lower value of the storage capacitor is required.

In the case where the ballast is able to provide its input constant current (minimum dimmer current) under any input conditions, for example by using conversion means, the capacitance C of the storage capacitor 36 can be calculated according to the following energy balance equation (valid for constant current):

$$T \cdot I \cdot {V}_{RMS} = \frac{C \cdot {V}^{2}}{2} \qquad ( 6 )$$

Here
T—maximum time needed to start the electronic converter (in the worst case it can be equal to or less than conduction time of the dimmer during the main half-period);
I—a current which is greater than max latching current of the dimmer's TRIAC by a certain safety margin;
V—the maximum voltage on capacitor C_{chg}.
V_{RMS}—the RMS value of the main voltage.

In the above described solution the minimum dimmer current is provided under any input conditions. In this solution, the current drawn from the dimmer to a special storage capacitance does not change with the input voltage. The current drawn to a storage capacitor at a maximum input voltage has the same value as for any other input voltage point. The energy received by the storage capacitance in order to provide stable dimmer operation is smaller than in other solutions and as result a significantly lower value of the storage capacitor is required.

The Ballast Control System 38 has an additional input 311 for feedback from the Inverter in order to disable the operation of the dimmer loader 30 after the start of the Inverter. In general, the operation of the dimmer loader during operation of the Inverter is not necessary since the consumption current of the Inverter is sufficient to hold on the dimmer. However, dimmer loader 30 may be activated to operate during every half-cycle of the mains period if, for example, the Inverter's load is very low and the consumption current approaches the hold-on current of the TRIAC.

The capacitor 36 is charged by dimmer loader 30 via diode 34 and Ballast 35. Capacitor 36 is discharged by the discharge resistor 37, when the power supply is turned off, or through diode 39 and main load capacitor 310 during operation of electronic converter.

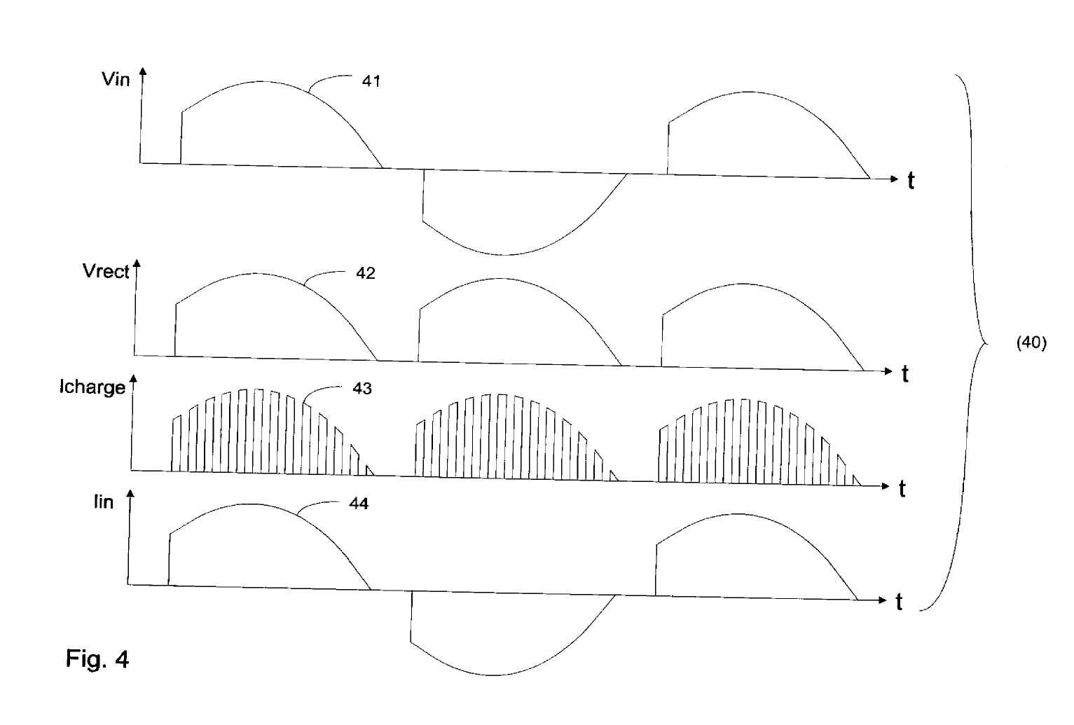

FIG. 4 illustrates the wave forms 40 that explain the operation of the Automatic Dimmer Loader. Vᵢₙ 41 is an AC voltage that TRIAC Dimmer 32 produces in FIG. 3. V_{rect} 42 is the rectified voltage after input Rectifier 33. I_{charge} 43 is the charging current of storage capacitor 36. I_{charge} 43 is a high-frequency pulsed current. Ballast Control System 38 chooses appropriate values of the current and width of current pulse in order to maintain the energy balance defined above. Iᵢₙ 44 is the current smoothed by an input EMI filter (which is not shown).

The main advantages of the ADL and method of the present invention are:
flexible control system, which maintains a stable operation of the system even at very small angles of the dimmer;
no distortions of the input signal; and

useful for a wide range of loads, e.g. lamps, drivers and other applications where there is a need to hold on the dimmer.

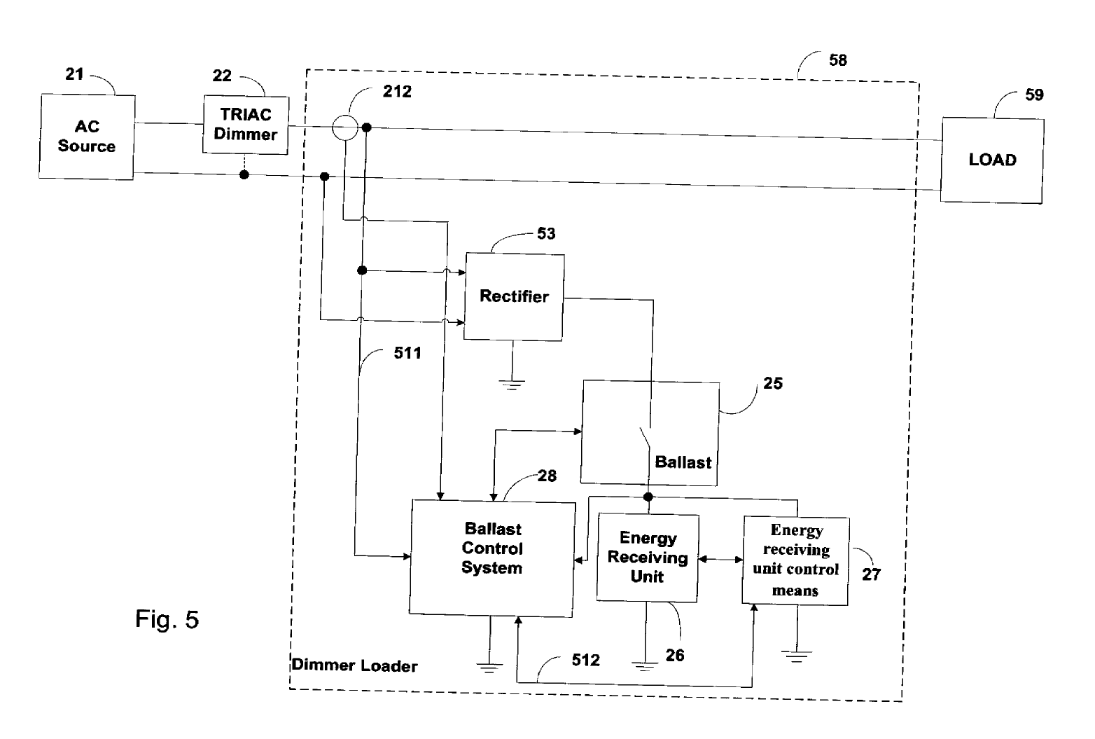

FIG. 5 shows the functional structure of an independent ADL 58 for the dimmer loading, constructed in accordance with the principles of the present invention.

ADL 58 is connected to the output of the TRIAC dimmer 52 which, in turn, is fed from AC Source 51. ADL 58 comprises an input current sensing means 510; a full wave rectifier 53, which rectifiers input AC voltage and whose output is connected to the input terminals of a ballast 54; ballast 54 which controls the dimmer 52 output current by using of sensing means 510, connected to the output terminals of rectifier 53; the energy receiving unit 56 and its control means 57 connected to the output terminals of ballast 54. Energy receiving unit control means 57 provide initial conditions for dimmer loader 58 operation. Ballast control system 55 controls ballast 54 current and has mains voltage input 511 and current feedback 510. Ballast control system 55 has control output 512, which is connected to control input of energy receiving unit control means 57 in order to synchronize ballast control system 55 and energy receiving unit control means 57.

Ballast control system 55 ensures that consumption current from the dimmer 52 is greater than hold-on current of dimmer's TRIAC. This can be achieved by monitoring the consumption current and its derivative this enables to achieve required consumption current at any conditions.

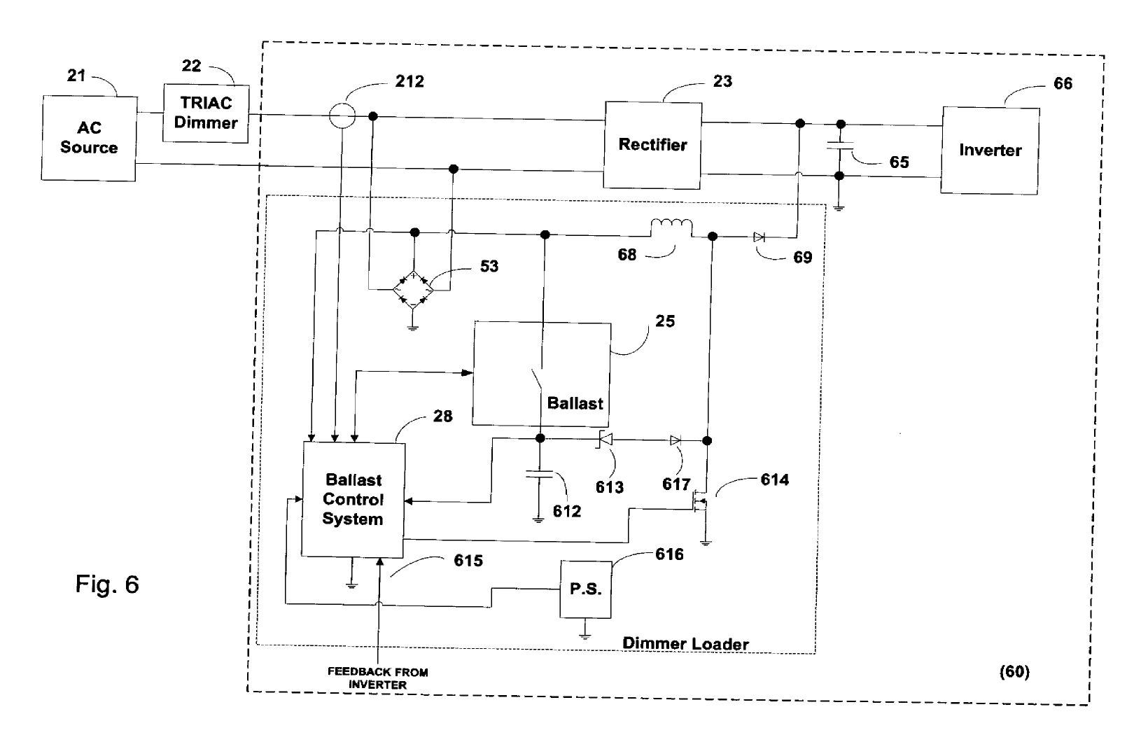

FIG. 6 shows the functional structure of an improved ADL 60 with energy utilization means constructed in accordance with the principles of the present invention. This structure is shown as an internal part of an electronic converter. Terminals of the AC source 61 are connected to the input terminals of a TRIAC dimmer 62. Output terminals of TRIAC dimmer 62 are connected to the input terminals of electronic converter's input rectifier 64 through a current sensor 63. Output terminals of the rectifier 64 are connected to an input bulk capacitor 65 of an inverter 66. Input terminals of a full wave rectifier 67 are connected in parallel to input terminals of rectifier 64. The negative terminals of both rectifiers 64 and 66 are connected together. A positive terminal of rectifier 67 is connected to a first terminal of inductor 68, to the voltage feedback input of ballast control system 611, and an input terminal of ballast 610. The second terminal of inductor 68 is connected to the anode of diode 69, drain of a MOSFET transistor 614, and cathode of diode 617. Anodes of Zener diode 613 and diode 617 are connected together. The source of a MOSFET 614 is connected to the negative terminal of rectifier 67. The output terminal of the ballast is connected to the first terminal of capacitor 612, cathode of Zener diode 613, and the voltage feedback input of ballast control system 611. The second terminal of capacitor 612 is connected to the negative terminal of rectifier 67. The ballast control signal from the output terminal of the ballast control system 611 is connected to the control terminal of ballast 610. Boost converter control signal from the output terminal of the ballast control system 611 is connected to the gate terminal of the MOSFET transistor 614. The output terminal of the internal power supply 616 is connected to the power terminal of the ballast control system 611. Input terminal of power supply 616 may be sourced from positive terminal of rectifier 64 or 67. The output terminal of current sensor 63 is connected to the input terminal of the ballast control system 611. The ballast control system 611 also takes the feedback input 615 from inverter 66.

The control system 611 operates in the following way: ballast 610 is configured so that it is normally closed, in order to conduct the current, at the time when the input voltage is initially applied. Capacitor 612 starts to consume current and the voltage on it rises. After a certain voltage rise ballast control system 611 starts its normal operation, i.e., it maintains the current flowing through TRIAC dimmer 62 at a level higher than the hold-on current of the latter. If the current consumption of the electronic converter approaches the value close to the dimmer's hold-on current, the control system 611 starts to maintain dimmer 62 current by means of ballast 610 current, at a level higher than the dimmer's latching current. The boost effect enables consumption of the required current from the dimmer at any given time. Zener diode 613, together with diode 617, prevent the rise of capacitors 612 voltage above a certain voltage level during the ADL operation.

The considerations for choosing the value of the capacitance of capacitor 612 are different from the ones described above in connection to energy equations (1), (2) and (3). In the present case, the capacitor 612 provides the initial conditions for dimmer latching during the delay when the boost converter is starting. In the case where ballast control system 611 is supplied from capacitor 612 when the boost converter starts, the ballast control system 611 reduces the charge current of capacitor 612 down to the level sufficient for power supplying of control system 611 from capacitor 612 and boost converter ensures current consumption from the dimmer at level greater that hold-on current of the dimmer 62. In this case, capacitor 612 loads the dimmer through ballast 610 for a period of time defined by the boost converters start-up time, which is typically in the range of 1-2 ms in the worst case. Therefore, the capacity of capacitor 612 is significantly lower, by about five to ten times, than in the former case where the capacitor 36 of FIG. 3 operates throughout the whole operating period of the dimmer in the worst case, i.e., without dimmer load. Furthermore, in the structure of FIG. 6, better energy utilization is achieved whereby all the energy consumed by the boost converter is transferred to the input bulk capacitor 65 of the electronic converter for further power conversion. The structure of FIG. 6 provides significant advantages for low power applications and improves the overall efficiency of the power conversion system.

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

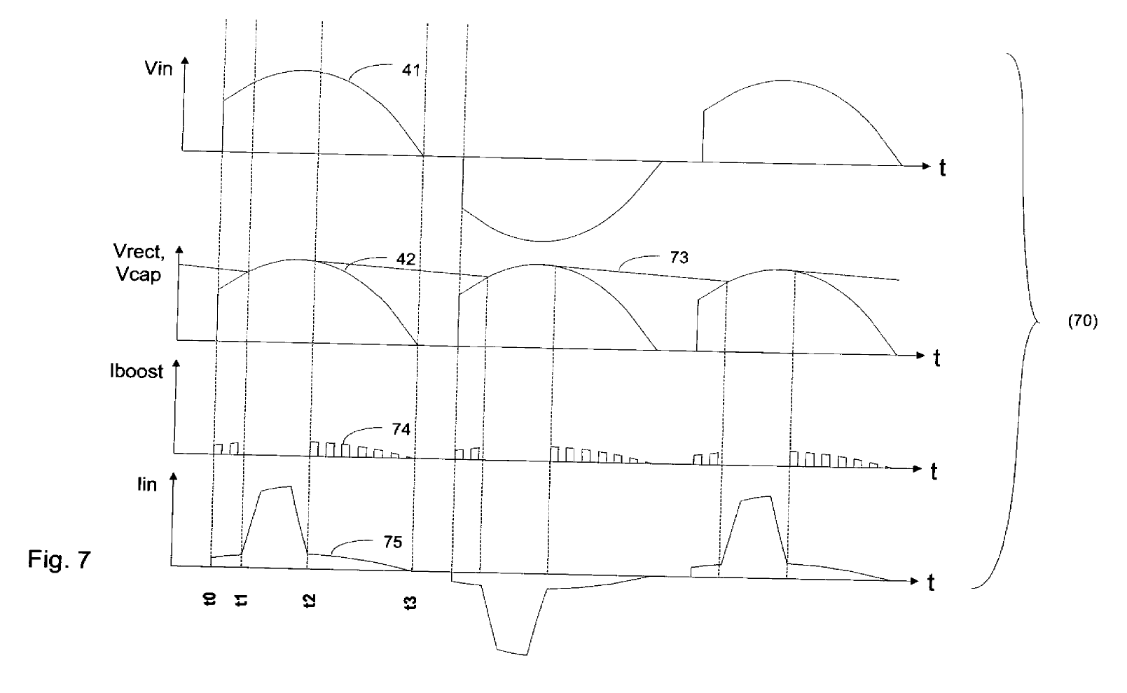

FIG. 7 shows the operational waveforms 70 of the adaptive loader described relative to FIG. 6. At time to DIAC 15 of the dimmer breaks down and TRIAC 14 is open, with reference to the components of prior art FIG. 1. Current starts to flow. Its value is defined by ADL and is greater than TRIAC 14 latching current. The electronic converter has not started yet. At time t1 the electronic converter starts its operation and the current flowing through dimmer's TRIAC 14 is defined by the load of the electronic converter. At time t2 the current flowing through the dimmer's TRIAC 14 and ADL maintains the current at the level greater than dimmer's TRIAC 14 latching current up to time t3 when dimmer’ TRIAC 14 is turned off. In the next half period of the main voltage the process is repeated.

1-48. (canceled)

49. A dimmer loader circuit comprising:
a ballast unit coupled to an output of a cut phase dimmer and configured to load the cut phase dimmer output with a loading current; and
a ballast control system coupled to the ballast unit and configured:
to determine a minimum loading current required for regular operation of the cut phase dimmer, and
to control the ballast unit so that the loading current would be substantially equal to the minimum loading current when a voltage is present at the cut phase dimmer output.

50. The dimmer loader circuit of claim 49, wherein the ballast control system is configured to determine the minimum loading current based on a predefined minimum dimmer current value.

51. The dimmer loader circuit of claim 50, wherein the dimmer loader circuit further comprises a current sensor for measuring a dimmer output current at the cut phase dimmer output, and the ballast control system is configured to determine the minimum loading current based on the predefined minimum dimmer current value by subtracting the measured dimmer output current from the predefined minimum dimmer current value.

52. The dimmer loader circuit of claim 49, wherein the ballast unit comprises an electronic switching converter.

53. The dimmer loader circuit of claim 52, wherein the electronic switching converter comprises a step down converter.

54. The dimmer loader circuit of claim 52, wherein the electronic switching converter comprises a step up converter.

55. The dimmer loader circuit of claim 49, further comprising a means for recuperating energy consumed by the ballast unit from the cut phase dimmer.

56. The dimmer loader circuit of claim 55, wherein the means for recuperating the energy consumed by the ballast unit from the dimmer is configured to transfer said energy consumed to a bulk capacitor coupled to the cut phase dimmer output.

57. A method for minimal loading of a cut phase dimmer, the method comprising the steps of:
determining a minimum loading current required for regular operation of the cut phase dimmer, and
controlling a ballast unit, coupled to an output of the cut phase dimmer, so that a loading current consumed by the ballast unit from the cut phase dimmer would be substantially equal to the minimum loading current as long when a voltage is present at the cut phase dimmer output.

58. The method of claim 57, wherein determining the minimum loading current is based on a predefined minimum dimmer current value.

59. The method of claim 58, wherein determining the minimum loading current based on the predefined minimum dimmer current value comprises measuring a dimmer output current and subtracting the measured dimmer output current from the predefined minimum dimmer current value.

60. The method of claim 57, wherein the ballast unit comprises an electronic switching converter.

61. The method of claim 60, wherein the electronic switching converter comprises a step down converter.

62. The method of claim 60, wherein the electronic switching converter comprises a step up converter.

63. The method of claim 57, further comprising the step of recuperating energy consumed by the ballast unit from the cut phase dimmer.

64. The method of claim 63, wherein recuperating the energy consumed by the ballast unit from the dimmer comprises transferring said energy to a bulk capacitor coupled to the cut phase dimmer output.
